(19) United States
(12) Patent Application Publication
(10) Pub. No.: US 2026/0196215 A1
(43) Pub. Date: Jul. 9, 2026

(54) VOICE-GUIDED DISPENSER CONTROL

(71) Applicant: Wayne Fueling Systems LLC, Austin, TX (US)

(72) Inventors: Aleksandra Pawlak-Burakowska, Kraków (PL); Piotr Sliwka, Kraków (PL); Piotr Piatek, Kraków (PL); Jerzy Zyglowicz, Wieliczka (PL)

(21) Appl. No.: 19/013,725

(22) Filed: Jan. 8, 2025

(51) Int. Cl. G10L 15/22; G05D 7/06; G10L 13/027; G10L 15/06; G10L 15/183

(52) U.S. Cl. CPC G10L 15/22; G05D 7/0617; G10L 13/027; G10L 15/063; G10L 15/183; G10L 2015/223

(57) ABSTRACT

Audible input data received via a product dispenser is received by a dialog processing system communicatively coupled to the product dispenser. The audible input data is received in the audible dialog responsive to a first indication of a first operating state of the product dispenser and is converted to textual input data. State data associated with the first operating state is determined. Textual output data is determined by a predictive model trained to generate textual output data contextually relevant to one or more operating states of the product dispenser. At least one dialog context of the audible dialog is determined for the textual output data. The textual output data is converted to audible output data that is provided via an output device of the product dispenser such that the product dispenser transitions from the fist operating state to a second operating state.

### FIELD

The current subject matter relates to methods and systems for controlling operations of a product dispenser via an audible dialog, such as a dialog of voice commands spoken by a user of the product dispenser configured in a dispensing environment. The product dispenser can be configured to receive audible dialog inputs and provide audible dialog outputs that are contextually relevant to operations of the product dispenser.

### BACKGROUND

The subject matter herein pertains to controlling a product dispenser using inputs that are provided verbally, or spoken, by a user of the product dispenser. The product dispenser can be configured to receive and process verbal inputs in a dialog with the product dispenser, determine one or more control signals controlling operation of the product dispenser, and to generate audible and visual outputs via the product dispenser. In this way, the product dispenser can provide different modalities for user interaction and can accommodate users who may have visual or audible impairments. Thus, the product dispenser can include an improved computing system configured to provide an enhanced user experience for operating the product dispenser and provide access to a broader range of users by offering additional or alternative input formats for controlling the product dispenser and providing input information about products or services that are available in the dispensing environment.

### SUMMARY

In one aspect, a method for providing voice-guided dispenser control is provided. In one embodiment, the method can include receiving, by a dialog processing system communicably coupled to a product dispenser, audible input data acquired via at least one input device of the product dispenser responsive to a first indication of a first operating state of the product dispenser. The audible input data can be received in an audible dialog configured to control one or more operating states of the product dispenser. The method can also include converting, by the dialog processing system, the audible input data to textual input data. The method can further include determining, by the dialog processing system, state data corresponding to the first operating state and associated with the audible input data. The method can also include determining, by a predictive model of the dialog processing system, textual output data corresponding to the textual input data and the state data. The predictive model can be trained in a machine learning process to receive textual input data and state data including display state data and operating state data associated with the one or more operating states of the product dispenser and to generate textual output data contextually relevant to the textual input data and the one or more operating states of the product dispenser. The method can further include determining, by the dialog processing system, at least one execution role of the product dispenser associated with the first operating state based on the textual output data. The method can also include converting, by the dialog processing system, the textual output data to audible output data responsive to determining the textual output data corresponds to the at least one execution role of the product dispenser. The method can further include providing, via the at least one output device of the product dispenser, the audible output data in the audible dialog such that the product dispenser transitions from the first operating state to a second operating state.

One or more of the following features can be included in any feasible combination. For example, in one embodiment, the at least one execution role can include a first execution role associated with providing the audible dialog and a second execution role with executing functionality associated with the one or more operating states of the product dispenser. In another embodiment, responsive to determining the textual output data corresponds to the first execution role, the method can further include providing the audible output data via a second indication of the second operating state of the product dispenser. In some embodiments, the first indication of the first operating state or the second indication of the second operating state of the product dispenser can be provided after expiration of a pre-determined period of time in which no audible input data is acquired via the at least one input device.

In another embodiment, responsive to determining the textual output data corresponds to the second execution role, the method can also include generating control signals configured to control the product dispenser to transition from the first operating state to the second operating state. In some embodiments, responsive to executing the generated control signals, the second operating state can be configured to provide one or more applications for display via the at least one output device. The one or more applications can include at least one of a weather application, a car wash application, and a point-of-sale application for purchasing an item or service at the product dispenser.

In another embodiment, the state data can characterize at least one of a display state of a display of the product dispenser and a pump state of a pump of the product dispenser. In some embodiments, the display state data can characterize at least one an activity message state, a softkey state, a grade key state, a stop button state, a volume state, a display language state, and a display contrast state and the pump state data characterizes at least one of an idle pump state and an active pump state. In another embodiment, the machine learning process in which the predictive model can be trained can be configured to train the predictive model to generate textual output data for use in the audible dialog with a user of the product dispenser. The dialog can be contextually relevant to the first operating state or the second operating state.

In some embodiments, at least one of the first operating state and the second operating state can include at least one of an idle state, a transaction initialization state, a payment preauthorization state, a dispensing start state, a dispensing complete state, a receipt creation state, and a transaction complete state. In another embodiment, the first indication of the first operating state can be provided after the product dispenser is in an idle state and responsive to detecting a user of the product dispenser. In some embodiments, the at least one output device of the product dispenser can include a display or a speaker. In another embodiment, the at least one input device of the product dispenser can include a display or a microphone.

In another aspect, a system for providing voice-guided dispenser control is provided. In one embodiment, the system can include a product dispenser, which can include at least one input device and at least one output device. The system can also include a dialog processing system which can be communicably coupled to the product dispenser and can include a memory storing computer-executable instructions, a predictive model which can be trained in a machine learning process to receive textual input data and state data including display state data and operating state data associated with one or more operating states of the product dispenser and to generate textual output data contextually relevant to the textual input data and one or more operating states of the product dispenser, and a data processor which can be configured to execute the instructions. The instructions, when executed can cause the data processor to perform operations which can include receiving audible input data acquired via the at least one input device of the product dispenser responsive to a first indication of a first operating state of the product dispenser. The audible input data can be received in an audible dialog configured to control one or more operating states of the product dispenser. The operations can also include converting the audible input data to textual input data. The operations can further include determining state data corresponding to the first operating state and associated with the audible input data. The operations can also include determining, by the predictive model, textual output data corresponding to the textual input data and the state data. The operations can further include determining at least one execution role of the product dispenser associated with the first operating state based on the textual output data. The operations can also include converting the textual output data to audible output data responsive to determining the textual output data corresponds to the at least one execution role of the product dispenser. The operations can further include causing the audible output data to be provided in the audible dialog such that the product dispenser transitions from the first operating state to a second operating state.

One or more of the following features can be included in any feasible combination. For example, in one embodiment, the at least one execution role can include a first execution role associated with providing the audible dialog and a second dialog execution role associated with executing functionality associated with the one or more operating states of the product dispenser. In another embodiment, responsive to determining the textual output data corresponds to the first execution role, the instructions can be further configured to provide the audible output data via a second indication of the second operating state of the product dispenser. In some embodiments, the instructions can be further configured to provide the first indication of the first operating state or the second indication of the second operating state of the product dispenser after expiration of a pre-determined period of time in which no audible input data is acquired via the at least one input device.

In another embodiment, responsive to determining the textual output data corresponds to the second execution role, the instructions can be further configured to cause the data processor to generate control signals configured to control the product dispenser to transition from the first operating state to the second operating state. In some embodiments, responsive to executing the generated control signals, the second operating state can be configured to provide one or more applications for display via the at least one output device, the one or more applications including at least one of a weather application, a car wash application, and a point-of-sale application for purchasing an item or service at the product dispenser.

In another embodiment, the state data can characterize at least one of a display state of a display of the product dispenser and a pump state of a pump of the product dispenser. In some embodiments, the display state data can characterize at least one an activity message state, a softkey state, a grade key state, a stop button state, a volume state, a display language state, and a display contrast state and the pump state data characterizes at least one of an idle pump state and an active pump state. In another embodiment, the machine learning process in which the predictive model can be trained can be configured to train the predictive model to generate textual output data for use in the audible dialog with a user of the product dispenser. The dialog can be contextually relevant to the first operating state or the second operating state.

In another embodiment, at least one of the first operating state and the second operating state can include at least one of an idle state, a transaction initialization state, a payment preauthorization state, a dispensing start state, a dispensing complete state, a receipt creation state, and a transaction complete state. In some embodiments, the first indication of the first operating state can be provided after the product dispenser is in an idle state and responsive to detecting a user of the product dispenser. In another embodiment, the at least one output device of the product dispenser can include a display or a speaker. In some embodiments, the at least one input device of the product dispenser can include a display or a microphone.

### BRIEF DESCRIPTION OF DRAWINGS

The details of one or more variations of the subject matter described herein are set forth in the accompanying drawings and the description below. Other features and advantages of the subject matter described herein will be apparent from the description and drawings, and from the claims. The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a diagram illustrating an example embodiment of a system for voice-guided dispenser control according to the subject matter described herein;

FIG. 2 is a diagram illustrating a detailed view of a dialog agent subsystem and a dialog processing subsystem of the system of FIG. 1;

FIG. 3A is a data flow diagram of data exchanged via the system of FIG. 1 during a first plurality of operating states of a product dispenser;

FIG. 3B is another data flow diagram of data exchanged via the system of FIG. 1 during a second plurality of operating states of a product dispenser;

FIG. 4A is a process diagram illustrating an example embodiment of a method for providing voice-guided dispenser control via the system of FIG. 1;

FIG. 4B is a process diagram continuing the example embodiment of the method from FIG. 4A for providing voice-guided dispenser control via the system of FIG. 1;

FIG. 5 is a system block diagram illustrating one embodiment of a dispensing system configured for use in the system of FIG. 1;

FIG. 6 is a system block diagram of a product dispenser configured for use in the system of FIG. 1;

FIG. 7 is a diagram illustrating a perspective view of an embodiment of the product dispenser of FIGS. 1, 5, and 6 configured to dispense a liquid product;

FIG. 8 is a perspective view of an embodiment of a dispenser configured to dispense electricity;

FIG. 9 is a front perspective view of an embodiment of a dispenser configured to dispense a gaseous product; and

FIG. 10 is a block diagram of an exemplary computing system configured for use in the system of FIG. 1.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Existing product dispensers can be limited to receiving inputs for controlling the product dispenser via manual inputs, such as pushing buttons, moving levers, or physically contacting touchscreen interfaces. Such actions can be problematic for users who may have limited manual dexterity or physical limitations, such as visual blindness, which preclude manual interaction with product dispensers. Additionally, some users may not wish to have physical contact with product dispensers due to transmission of possible germs, dirt, or unhygienic materials. Further, existing product dispensers which lack voice-guided dispenser control mechanisms may limit personalization of the user experience, which can lead to lower sales and reduced operating profits. The mechanical and computational complexity of product dispensers requiring manual input of dispenser operating inputs can also increase due to the need for multiple types of input devices and the communicative coupling required between the manual input devices, which can result in increased operation and maintenance costs, increased operational downtime when manual input devices fail, and the need to maintain adequate inventory of manual input devices in order to efficiently remedy inoperative manual input devices.

The voice-guided dispenser control system provided herein can address the aforementioned issues and can provide an improved computing system for controlling operation of product dispensers. The system herein can receive audible inputs from a product dispenser user and can return audible outputs in a dialog with the user. The system can be configured to manage and control display states of a display of the product dispenser, but also to manage and control operating states of the product dispenser. A dialog processing sub-system of the system herein can provide contextually relevant dialog responses to the user that can be coordinated with dispenser control, such as changes in dispenser display states and changes in the dispenser operating state. As a result, the user can experience an improved and personalized interaction operating the product dispenser. For example, the system provided herein can be configured to afford individuals with physical or visual disabilities the capability to conduct dispensing operations themselves and without the need to assistance. The system can provide additional advertising or marketing channels to audibly guide users to promotions or offers for goods or services that may be available from adjacent or related retail facilities. The dialog provisions made possible by the system described herein can also provide a more personalized user experience with regard to gender, age, language, and dialog tone, when performing dispensing operations or when providing assistance for non-fueling related topics, such as weather forecasts, directions, traffic, or municipal alerts (e.g., amber alerts).

The system described herein can implement a unique data exchange and computing system that includes a dialog agent configured on a computing device of the product dispenser and a dialog processing sub-system configured on another computing device communicatively coupled to the product dispenser. The dialog agent can be configured to capture and transmit display state data associated with a display of the product dispenser and audible input data captured via an input device of the product dispenser, such as a microphone. The display state data and audible input data can be provided by a user in regard to an operating state of the product dispenser and can be transmitted by the dialog agent to the dialog processing sub-system, where once received a generative language model can process textualized versions of the audible input data and to determine contextually relevant textual output data associated with the operating state and/or the display state of the product dispenser. The textual output data can be converted into audible output data that can be returned to the dialog agent and provided to the user via an output device of the product dispenser, such as a speaker. The generative language model can be trained in a machine learning process to generate contextually relevant dialog responses or output data related to one or more operating states of the product dispenser or one or more display states of the display of the product dispenser. The generative language model can also be trained to generate dialog responses or output data that is related to non-fueling related activities, such as weather, traffic, navigation, or the availability of goods and services at a retail environment associated with the product dispenser.

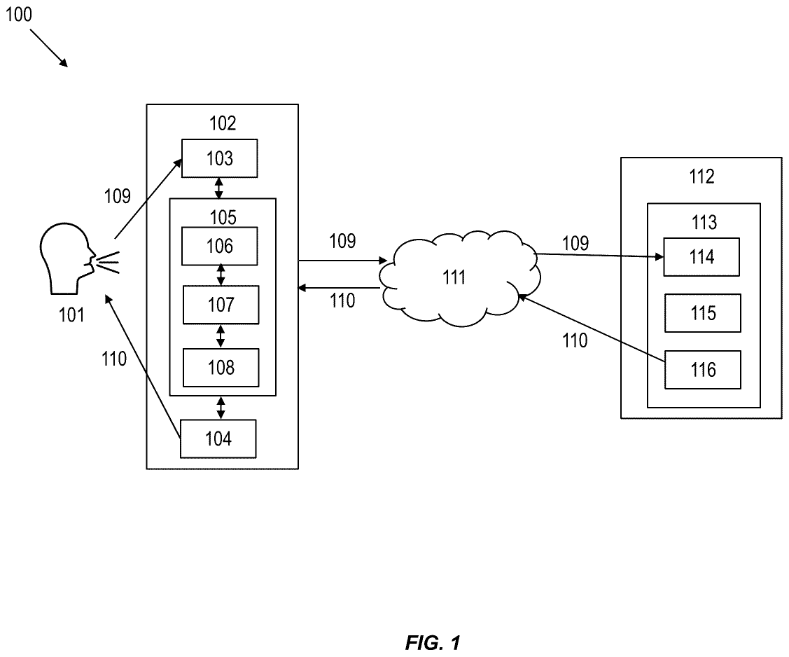

As shown in FIG. 1, a system 100 is provided for performing voice-guided dispenser control. A user 101 can interact audibly with a product dispenser 102. The product dispenser 102 can be communicatively coupled to a remote computing device, such as a server 112, via a network 111. The product dispenser 102 can be configured to dispense fuel, electricity, or similar fueling products and can include at least one computing device therein. The product dispenser 102 can also include an input device 103, such as a microphone, and an output device 104, such as a speaker. The product dispenser can further include a dialog agent subsystem 105 including a display 106, a display controller 107 configured to receive and generate control signals configured to control display of graphical and textual content in the display 106, and a dialog agent 108 configured to receive display state data acquired via the display controller 107. The display state data can include executable instructions associated with displaying graphical or textual content on the display 106 and can be associated with one or more operating states of the product dispenser 102. The dialog agent 108 can be configured to provide audible input data to the dialog processing subsystem 113 configured on the server 112 and to receive audible output data from the same.

The server 112 can include a dialog processing subsystem 113 configured therein. The dialog processing subsystem 113 can include a speech-to-text synthesizer 114, a generative language model 115, and a text-to-speech synthesizer 116. The speech-to-text synthesizer can receive audible input data from the dialog agent 108 and can convert it to textual input data (e.g., a textual version of a dialog input) that is provided back to the dialog agent 108. The dialog agent 108 can then provide the textual input data and state data associated with an operating state of the product dispenser 102 (or components thereof) to the generative language model 115, which can be configured to generate textual output data that is contextually relevant to the textual input data (e.g., a textual version of a dialog output) and the state data associated with the operating state. The generative language model 115 can be trained in a machine learning process to receive the textual input data associated with the audible input data and the state data associated with an operating state of the product dispenser or components therein and textual input data and to generate contextually relevant dialog responses to the textual input data as textual output data. The generated textual output data can be received from the generative language model 115 by the dialog agent 108 and can be provided to the text-to-speech synthesizer 116 for conversion to audible output data. The audible output data can be returned to the dialog agent 108 and provided as an audible output to the user 101 via the output device 104 of the product dispenser 102.

In operation, the user 101 can utter or speak audible input data 109 to the input device 103 of the product dispenser. The dialog agent 108 can provide the audible input data 109 to the server 112 via the network 111. Once received, the audible input data 109 can be converted to textual input data by the speech-to-text synthesizer 114 and the textual input data can be returned to the dialog agent 108. State data associated with an operating state of the product dispenser 102 or components therein can be gathered and can be provided to the generative language model 115 with the textual input data for determination of a contextually relevant response to the audible input data 109. The generative language model 115 can generate the response and provide textual output data corresponding to the determined response to the dialog agent subsystem 108, where once received it can be provided to the text-to-speech synthesizer 116. The text-to-speech synthesizer 116 can convert the textual output data to audible output data 110, which can be provided to the dialog agent 108. Once received, the dialog agent 108 can provide the audible output data 110 to the user 101 via the output device 104 of the product dispenser 102.

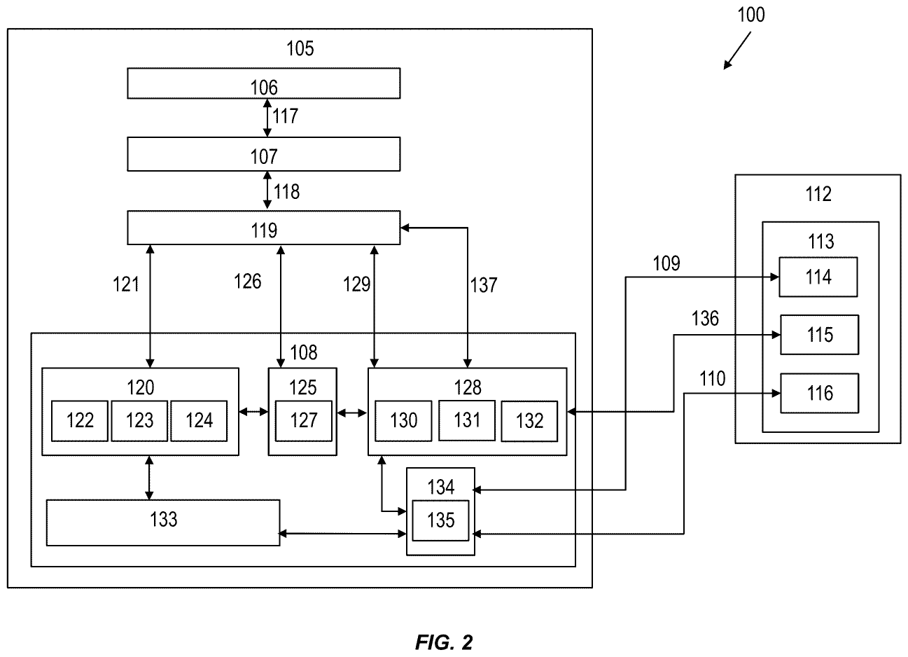

The dialog agent subsystem 105 can include a number of components and/or services configured to support voice-guided dispenser control of the product dispenser 102 via dialogs generated by the dialog processing sub-system 113. For example, as shown in FIG. 2, a detailed view of the dialog agent subsystem 105 is illustrated. The dialog agent subsystem 105 can include the display 106 of the product dispenser 102, which can be communicatively coupled to a display controller 107. The display controller 107 can provide control signals 117 to the display 106 that are configured to control presentation of graphical and textual content on the display 106. The display controller 107 can be communicatively coupled to a message queue 119. The message queue 119 can receive data 118 from the display controller 107 that is indicative of the presented graphical or textual content displayed via the display 106, as well as any inputs received via the display 106, such as user inputs provided to graphically displayed buttons, keys, icons, or the like. In some embodiments, the data 118 can include display state data 121 and 129 associated with a state of the display 106 and pump state data 126 associated with a state of a pump of the product dispenser 102. The data 118 (and thus display state data 121, 129 and the pump state data 126) can be provided to the dialog agent 108 for further processing.

The dialog agent subsystem 108 can include a number of communicably coupled components or services configured to process the display state data 121 and 129 and pump state data 126 and to exchange data with the dialog processing subsystem 113. For example, the dialog agent subsystem 108 can include a screen data service 120 configured to acquire display state data 121 associated with currently displayed text prompts and graphical elements that are displayed on the display 106 from the message queue 119. The display state data 121 can include screen display data associated with the textual prompts and graphical elements and change display language data or code associated with modifying a displayed language of textual prompts provided via the display 103. In this way, the dialog agent subsystem 108 can be informed of an overall display state of the display 106 and presented content (e.g., textual or graphical prompts, icons, buttons, soft keys, or the like) provided via the display 106. Language settings of the displayed textual content can also be configured via the screen data service 120. For example, the screen data service can include a translator 122 configured to perform language translation of displayed textual content. The screen data service 120 can also include a softkey handler 123 that can be configured to control data associated with virtual buttons or soft keys that are displayed via the display 106. For example, the soft key handler 123 can be configured to process data associated with input of user selections provided to the virtual buttons or soft keys such that the soft key handler 123 can determine which buttons have been pressed or activated via tactile or audible inputs. In this way, the dialog processing subsystem 108 can provide state data indicative of a display context of displayed buttons or soft keys at a particular time to the generative language model 115 to aid the generative language model 115 in generating contextually relevant dialog outputs that correspond to the display state of the display 106 and the operating state of the product dispenser 102. The screen data service 120 can also include a prompt handler 124 that can be communicably coupled with the translator 122 and the softkey handler 123. The prompt handler 124 can be configured to configure and manage the display or audible provision of prompts (e.g., a prompt for a user to input a zip code for authorization of a user credit card that can be displayed on the display 106 and spoken audibly to the user 102 via the output device 104).

The dialog agent subsystem 108 can also include a pump state service 125 configured to receive pump state data 126 from the message queue 119. The pump state service 125 can include a pump state machine 127 configured to manage changes in an operating state of a pump of the product dispenser 102 that are conveyed via the pump state data 126 so that the dialog agent subsystem 108 can remain synchronized with the operating state of the pump of the product dispenser 102. The pump state data 126 can include data associated with operating states of the pump of the product dispenser 102. In some embodiments, the pump state data 126 can be associated with an operating state of the product dispenser 102. The operating states of the product dispenser can include an idle state, a transaction initialization state, a payment preauthorization state, a dispensing start state, a dispensing complete state, a receipt creation state, and a transaction complete state. The pump state machine 127 can be configured to manage state data of the pump in regard to dialog inputs. For example, the pump state machine 127 can be configured to cause the dialog processing subsystem 108 to ignore dialog inputs that are unaffiliated with specific pump operating states. For example, the pump state machine 127 can be configured to cause an audible input selecting a fuel grade to be ignored when a prompt for an input of a zip code is provided visually or audibly. In this way, the pump state machine 127 can be configured to maintain the current operating state of the pump of the dispenser 102 during dispensing transactions.

The dialog agent subsystem 108 can also include a language model service 128 configured to receive display state data 129 from the message queue 119 and to generate prompt data 136 provided to the generative language model 115. For example, the language model service 128 can include a plurality of communicably coupled components, such as a model configurator 130, a model asker 131, and tools 132 configured to call the display controller 107 by publishing data to the message queue 119. The display state data 129 can include data associated with display of prompts, activity messages, or graphical and textual affordances that are provided via the display 106. The display state data 129 can include data associated with inputs received via the display 106 that are associated with user inputs provided to graphical elements on the display 106, such as an activity message associated with performing an activity associated with the dispenser 102, such as a payment authorization, a dispenser initiation activity, or changing the volume of the output device 104. The display state data 129 can also include data indicating selection of (or user interaction with) a graphical button, a soft key, a fuel grade selection icon, a stop icon, a change language button, and a change display contrast button. The display state data 129 can enable the dialog agent subsystem 108 to maintain a current state of any displayed graphical elements provided via the display 106 that are associated with one or more operating states of the product dispenser 102.

The language model service 128 can include a model configurator 130 configured to manage and configure aspects of the generative language model 115. For example, the model configurator can be configured to implement a desired language in which the generative language model 115 should generate textual output data for dialog responses. The model configurator 130 can be configured to select the desired language of the generative language model 115 from a plurality of available languages. In some embodiments, the model configurator 130 can configure dialog parameters associated with the generative language model 115, such as a dialog temperature, a language dialect, and/or a prompt length. The dialog temperature can be associated with a measure of formality/informality of language implemented by the generative language model 115. The language dialect can reflect a particular variant of a configured language which may be specific to a region or location in which the dispenser 102 is configured. The prompt length can correspond to a token length or a number of words for which the generative language model 115 defines as a single input.

The model asker 131 can be configured to exchange prompt data 136 with the generative language model 115. For example, the model asker 131 can convey the display state data 121, 129, and the pump state data 126 to the generative language model 115 as prompt data 136, such as in a prompt request provided to the generative language model 115. The prompt request can also include the textual input data that was converted from the audible input data by the speech-to-text synthesizer 114. Once the state data 121, 126, and 129 are received with the textual input data, the generative language model 115 can generate a prompt response as prompt data 136. The prompt response can include the textual output data that is contextually relevant to the textual input data and to one or more operating states of the dispenser 102 and is generated based on the state data 121, 126, and 129. The prompt response can be returned to the model asker 131 for further processing by the dialog agent subsystem 108.

In some embodiments, the model asker 131 can be configured to determine and operate in one or more execution roles of the dialog agent subsystem 108 based on the prompt data 136. Parameter values indicating one or more of the execution roles can be included in the prompt data 136 provided to or received from the generative language model 115. For example, the model asker 131 can evaluate prompt data 136 and determine or configure one or more execution roles. The execution roles can include a system role, a user role, an assistant role, or a tools role. The system role can provide set-up or configuration data that can inform the behavior of the generative language model 115. The set-up or configuration data can include instructions or implement guidelines for dialogs. Inputs to the generative language model 115 from the model asker 115 in the system role can have the highest priority compared to other inputs and the inputs defined by a system role may not be overridden by a different execution role later in a dialog. The system role can be configured to configure and manage a dialog provided by the generative language model 115. For example, the model asker 131 can define use of a system role to define an interaction style or tone of the dialog outputs generated by the generative language model 115. The system role can define whether or not the generative language model 115 should maintain a formal tone or interaction style throughout a dialog or if there are certain input topics to be avoided during a dialog, such as dialog inputs associated with political topics.

The model asker 131 can also be configured to determine and operate in a user role. The user role can represent the human user in the dialog. Prompt data 136 defined with a user role can reflect the actual audible inputs received from the user that are provided as textual input data to the generative language model 115. The user role can be applied to prompt data 136 when the human user 101 is providing an audible input 109 associated with a dialog question or statement.

The model asker 131 can also be configured to receive textual outputs from the generative language model 115 that include execution roles defined and applied to prompt data 136 by the generative language model 115. For example, the generative language model 115 can determine and apply parameters associated with execution roles that include an assistant role and a tool role to the textual output data generated by the generative language model 115. The assistant role can be the dialog generating role of the generative language model 115 and thus can operate to response to user inputs based on the textual input data and the state data 121, 126, 129 that are received by the generative language model 115. The assistant role is a default configuration of the generative language model 115 when responding to user inquiries in a dialog.

The model asker 131 can also be configured to receive textual outputs from the generative language model 115 that include a tool roles defined and applied to prompt data 136 by the generative language model 115. For example, the generative language model 115 can determine and apply parameters associated with the tool role when it is necessary to call or execute functionality associated with controlling operation of the dispenser 102. For example, prompt data 136 generated by the generative language model 115 and defined by a tool role can cause the dialog agent subsystem 108 to pass parameters for executing dispenser functionality based on previous prompts 136 and/or dialog inputs. The tool role can be applied when the generative language model 115 determines that prompt data 136 (e.g., a prompt response) should include a function or operation of the product dispenser 102 to be triggered or executed based on prompt data 136 (e.g., a prompt request) that is received. For example, responsive to receiving prompt data 136 indicating a display state data 129 associated with a fuel grade selection, the generative language model 115 can generate and provide prompt data 136 that includes a tool role setting configured to cause the product dispenser 102 to select the desired fuel grade selection indicated in the display state data 129.

The language model service 128 can also include a tool module 132. The tools module 132 can be configured to manage execution of functions for controlling the dispenser 102 based on the prompt response 136 generated by the generative language model 115 that includes a tool role parameter. For example, based on a particular prompt response 136, the tool module 132 can publish control signals 137 to the message queue 119 to cause other components of the dispenser 102 to execute functionality associated with the control signals. For example, the tool module 132 can generate control signals to cause selection of a particular fuel grade, to cease operation of the pump of the product dispenser at completion of a fueling operation, or to cause one or more applications to be provided via the display 106 responsive to a user input selecting the one or more applications from a menu of applications to be provided for display.

The dialog agent subsystem 108 can also include agent service 133. The agent service 133 can handle a dialog flow between the user 101 and the dialog processing sub-system 113. The agent service 133 can be configured to manage the overall data exchange and control of data exchanged within dialog agent subsystem 108, such as data exchanged between the services 120, 125, 128, and 134.

The dialog agent subsystem 108 can also include a voice service 134 configured to provide speech recognition and synthesis abstractions and management of hardware devices, such as input devices 103 and output devices 104. The voice service 134 can include an audio manager 135 that can be communicatively coupled to the input device 103 and the output device 104 and is configured to manage settings or aspects of the input device 103 and the output device 104. In some embodiments, the voice service 134 can be configured to apply audible data settings, such as a voice style, a gender identification, or an emotion style, to the audible output data 110 that is generated by the text-to-speech synthesizer 116 based on the for the textual output data generated by the generative language model 115.

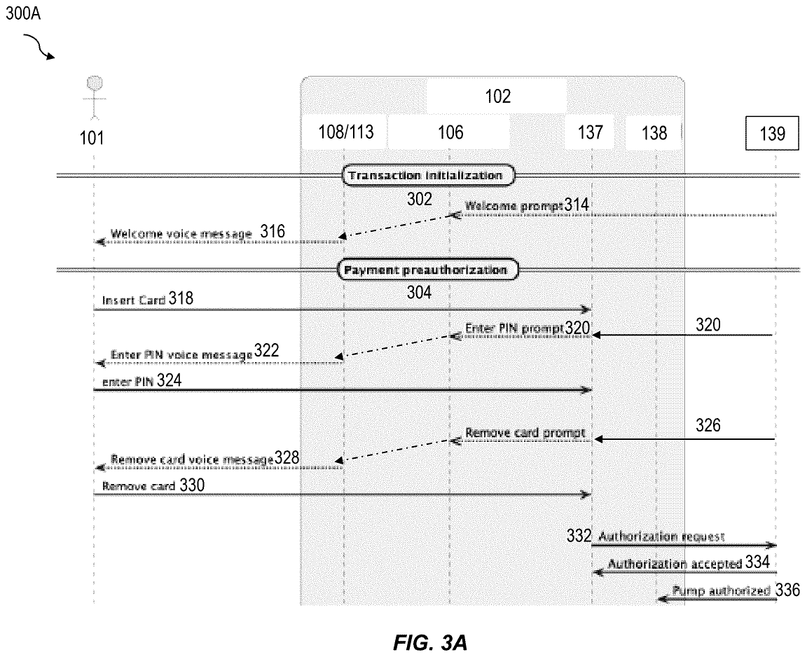

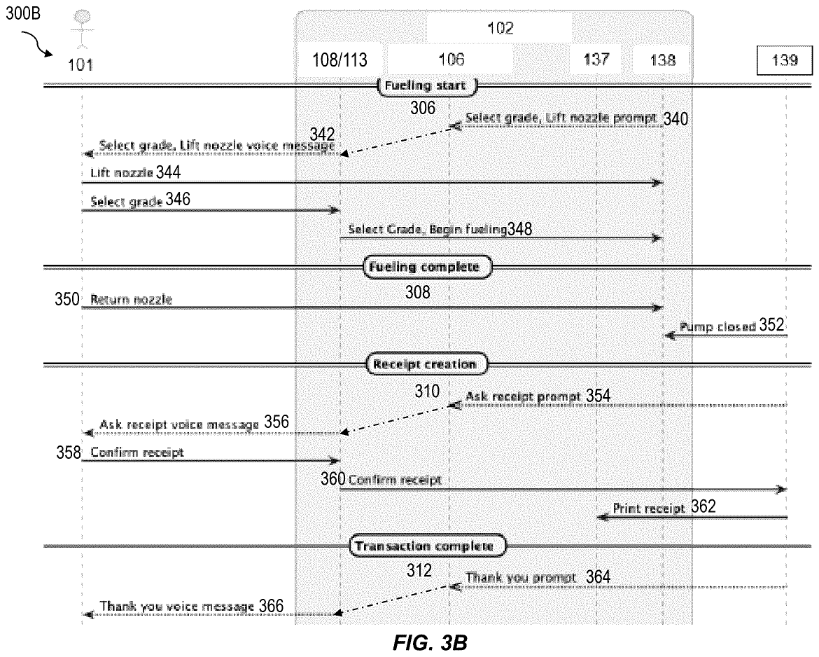

FIGS. 3A-3B illustrate a plurality of operating states 302-312 in which the product dispenser 102 can be configured to perform transaction and dispensing operations. The system 100 can be configured to utilize operating state data associated with the operating states 302-312 to generate contextually relevant dialog output data that can be provided as audible output data 110 and to generate display state data associated with graphical or textual elements to be displayed via the display 103. For example, as shown in FIG. 3A, a first operating state 302 can correspond to a transaction initialization state. The product dispenser 102 is in an idle state and a point-of-sale (POS) device or component 139 that is communicably coupled to the product dispenser 102 can be configured to generate instructions to cause a graphical indication 314 of the operating state 302 to be displayed on the display 106. The graphical indication 314 can be a welcome prompt that can be displayed on the display 106. Responsive to displaying the graphical indication 314, the dialog agent subsystem 108 and dialog processing subsystem 113 can be configured to listen for control signals posted to the message queue 119 regarding the display of the graphical indication 314 and can cause the dialog agent subsystem 108 to generate an audible indication 316 that can be provided to the user 101 via the output device 104. The dialog agent subsystem 108 can generate the audible indication 316 responsive to detecting (e.g., via an input device 103, such as a camera configured to collect image data) the user 101 present at the dispenser 102.

As shown in FIGS. 3A-3B, the dashed line between the display 106 and the dialog agent subsystem 108 and dialog processing subsystem 113 indicates that coordination between displayed data and processing performed by the dialog agent subsystem 108 and dialog processing subsystem 113 as described herein. For example, responsive to the POS 139 causing a welcome prompt 314 to be displayed on the display 106, the dialog processing agent 108 can listen to, observe, or be subscribed to control messages posted to the message queue 119 for execution by the display controller 107 and can coordinate associated audible dialog processing with the generative language model 115 that is associated with the displayed content based on the particular operating state of the product dispenser 102. In this way, the dialog processing agent 108 senses and detects the state of the displayed content and the operating state of the product dispenser 102 to provide voice-guided dialogs controlling operation of the product dispensers in the various operating states that the product dispensers is configured to operate.

As further shown in FIG. 3A, a second operating state 304 can correspond to a payment preauthorization state. For example, a user 101 can insert a payment card and data associated with the payment card can be provided 318 to a secure payment module (SPM) 137, such as a card reader. The SPM 137 can generate a graphical indication, e.g., a prompt 320, to be displayed via the display 106 asking the user to enter a personal identification number (PIN) that associated with authorizing transactions via the card. Responsive to displaying the graphical indication 320, the dialog agent subsystem 108 and dialog processing sub-system 113 can be configured to generate an audible second indication 322 provided via the output device 104 instructing the user 101 to enter their PIN based on the data posted to the message queue 119. The user 101 enters the PIN data 324 via the SPM 137, such as via a keypad of the SPM 137 and the SPM 137 is configured to cause a graphical indication 326 to be displayed via the display 106 instructing the user to remove the card. Responsive to displaying the graphical indication 326, an audible indication 328 can be generated by the dialog agent subsystem 108 and dialog processing subsystem 113 based on the data posted to the message queue 119 and provided via the output device 104 instructing the user 101 to remove their card. The user 101 can remove 330 their card from the SPM 137 and the SPM 137 can generate and provide 332 an authorization request to the POS 139 communicably coupled to the product dispenser 102 and configured to authorize use of payment instruments. The POS 139 can generate and provide 334 an authorization approval to the SPM 137 and can further generate and provide 336 control signals to a pump controller 138 indicating that the pump is authorized for dispensing operations.

Having preauthorized the user's payment at the SPM 137 and the pump controller 138, the product dispenser 102 can transition to a third operating state 306 shown in FIG. 3B, which continues from FIG. 3A. The third operating state 306 can correspond to initiation of product dispensing. The pump controller 138 can cause a graphical indication 340 instructing the user to select a grade of product (or fuel) and lift the nozzle to be generated and provided via the display 106. Responsive to the graphical indication 340, the dialog agent subsystem 108 and dialog processing subsystem 113 can generate and provide an audible indication 342 instructing the user 101 to select a grade of fuel and lift the nozzle via the output device 104 based on the data posted to the message queue 119. The user can lift 344 the nozzle, which can cause control signals to be provided to the pump controller 138 to ready the pump to dispense fuel. The user 101 can provide an audible input 346 selecting a grade. For example, the user 101 can verbally say “Select unleaded grade 88” or “Select diesel”. The dialog agent sub-system 108 and dialog processing sub-system 113 can receive the audible input 346 via the input device 103 and can generate 348 control signals to cause the pump controller 138 to select the fuel grade corresponding to the audible input 336 and to initiate dispensing products.

In a fourth operating state 308, the user 101 has finished dispensing and returns 350 the nozzle to the product dispenser 102, which causes control signals to be provided to the pump controller 138 indicating the dispensing is complete. The POS 139 can generate control signals 352 to the pump controller 138 causing the pump of the product dispenser 102 to cease dispensing operations.

In a fifth operating state 310, the POS 139 can generate control signals to cause a graphical indication 354 to be provided via the display 106 asking the user 101 for a receipt of the payment transaction for the dispensed product. Responsive to providing the graphical indication 354, an audible indication 356 can be generated by the dialog agent subsystem 108 and the dialog processing subsystem 113 based on data posted to the message queue 119 and provided via the output device 104 prompting the user 101 whether or not they wish to receive a receipt. The user 101 can provide an audible input 358 via the input device 103 confirming they wish to receive a receipt. The audible input 358 can be provided to the dialog agent sub-system 108 and the dialog processing sub-system 113, which can generate 360 control signals indicating the receipt request and providing the control signals to the POS 139. The POS 139 can in response, transmit 362 control signals to the SPM 137 to print the receipt. In some embodiments, the SPM 137 can be configured with a paper printer device configured to print paper receipts. In some embodiments, the SPM 137 can be configured to generate a digital receipt that can be provided to the user 101 electronically via SMS text message or email.

In a sixth operating state, the dispenser 102 can complete the transaction. For example, the POS 139 can generate control signals to cause a graphical indication 364 to be displayed via the display 106 of the dispenser 102 thanking the user 101 for using the product dispenser 102. Responsive to providing the graphical indication 364, the dialog agent subsystem 108 and the dialog processing subsystem 113 can be configured to generate an audible indication 366 based on the data posted to the message queue 119 and provide the audible indication 366 via the output device 104 thanking the user 101 for using the product dispenser 102.

In some embodiments, during one or more of the operating states 302-312, the graphical or audible indications described above can be provided after expiration of a pre-determined amount of time during which no audible input data 109 is received via the input device 103. In this way, the system 100 can ensure it has fully received the audible input data intended to be provided by the user 101 and does not initiate processing of the audible input data 109 prematurely.

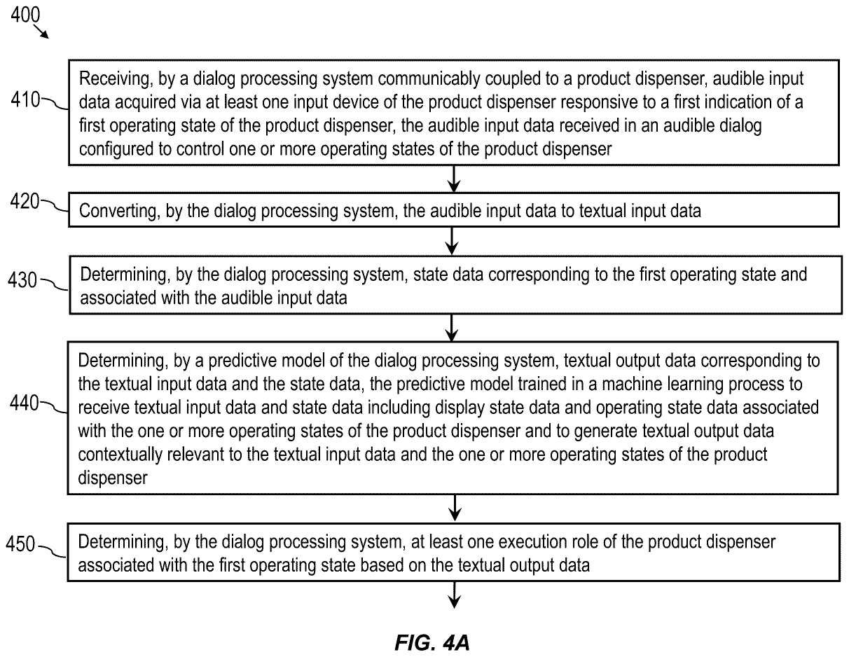

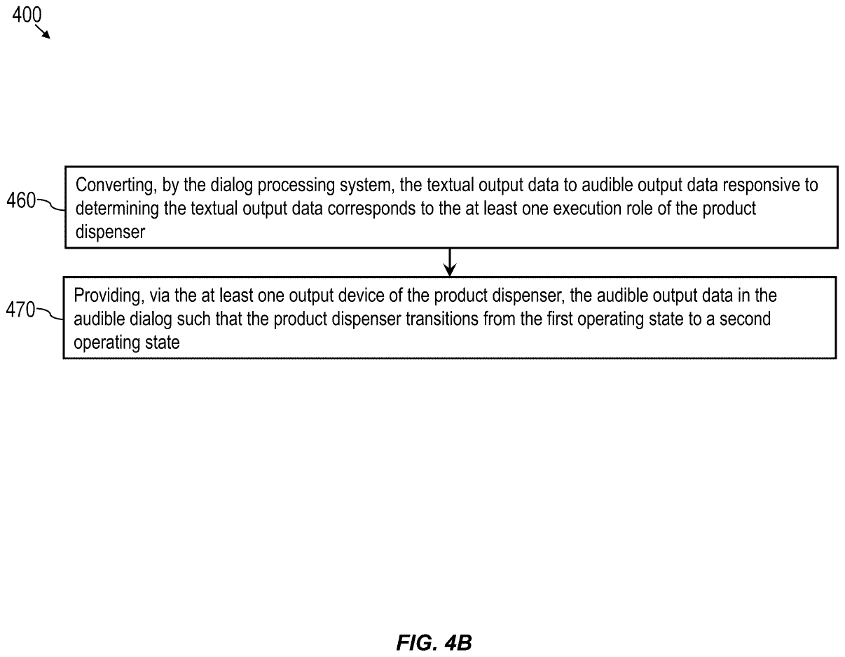

FIG. 4 illustrates an exemplary method 400 performed by the system of FIGS. 1 and 2 to provide voice-guided control of the product dispenser 102 for one or more of the operating states of the product dispenser 102 shown and described in relation to FIGS. 3A-3B. Steps 410-450 of the method 400 are illustrated in FIG. 4A and steps 460-470 of the method 400 are illustrated in FIG. 4B, which continues from FIG. 4A.

At 410, audible input data 109 can be received via an input device 103 in response to a first indication of a first operating state of the product dispenser 102. The audible input data 109 can be received in an audible dialog with the dialog agent subsystem 108 and dialog processing subsystem 113 that is configured to control one or more operating states of the product dispenser described in relation to FIGS. 3A-3B. For example, when the product dispenser 102 is in the operating state 306 configured to initiate dispensing a product, an indication 342 can be generated and provided via the output device 104 asking the user 101 to select a product grade and to lift a nozzle of the product dispenser 102 to commence dispensing the product. The user 101 can provide an audible input 346 via input device 103 selecting a grade of product to be dispensed. The audible input 346 can be received by dialog agent subsystem 108 as audible input data 109 and provided to the dialog processing subsystem 113.

At 420, the dialog processing subsystem 113 can convert the audible input data 109 corresponding to audible input 346 to textual input data via the speech-to-text synthesizer 114. The textual input data can be returned to the dialog agent subsystem 108 for incorporation into prompt data 136 with state data 121, 126, and 129 for use in determining a contextually relevant response by the generative language model 115.

At 430, the dialog agent subsystem 108 can determine state data corresponding to the operating state based on the state data 121, 126, and 129 acquired from the message queue 119. The state data 121, 126, and 129 can be associated with the audible input data receive at 410 and converted to textual input data at 420. The dialog agent subsystem 108 can prepare a prompt 136 (e.g., a prompt request) that includes the textual input data and the state data 121, 126, and 129 and provide the prompt data 136 to the generative language model 115 for processing.

At 440, the generative language model 115 can determine textual output data corresponding to the textual input data (e.g., the textual representation of the audible input data 109 corresponding to the audible input 346) and the state data 121, 126, 129. For example, the generative language model 115 can determine that based on the textual input data and the state data 121, 126, 129, that an appropriate dialog output or response would be to confirm the product grade selected by the user 101. A prompt 136 (e.g., a prompt response) can be generated by the generative language model 115 including the textual output data indicating confirmation of the selected grade of fuel and can be provided back to the dialog agent subsystem 113.

The generative language model 115 can be trained in a machine learning process to receive textual input data and state data including display state data and operating state data associated with one or more operating states of the product dispenser 102 and to generate textual output data that is contextually relevant to the textual input data and the one or more operating states of the product dispenser 102. Additional details of the machine learning process and training the generative language model 115 will be described later.

At 450, the textual output data generated by the generative language model 115 can be evaluated by the dialog agent subsystem 108 or the generative language model 115 to determine whether the textual output data corresponds to at least one execution role of the audible dialog associated with a particular operating state. For example, as described earlier, the generative language model 115 can determine and apply parameter values to the prompt data 136 (e.g., the prompt response) indicating that the prompt data 136 is associated with an assistant role or a tool role. Similarly, the dialog agent subsystem 108 can determine and apply parameter values to the prompt data 136 indicating that the prompt data 136 (e.g., a prompt request) that is provided to the generative language model 115 is associated with a system role or a user role. Thus, in some embodiments, e.g., when the dialog agent subsystem 108 is generating prompt data 136 associated with a prompt request, step 450 can be performed prior to step 440 so that the generative language model 115 is aware of the execution role specified by the model asker 131 as described earlier.

As shown in FIG. 4B, at 460, the textual output data generated by the generative language model 115 can be converted to audible output data 110 responsive to determining that the textual output data determined at 440 corresponds to an execution role determined at 450. For example, responsive to determining the textual output data corresponds to a first execution role associated with an assistant role, the dialog processing subsystem 113 can be configured to provide the textual output data to the dialog agent subsystem 108, which can provide the textual output data to the text-to-speech synthesizer 116 for conversion to audible output data 110. The audible output data 110 can be returned to the dialog agent subsystem 108 for provision to the user 101 via the output device 104 of the product dispenser 102.

At 470, the audible output data 110 can be provided in a dialog with the user 101 via the output device 104. In some embodiments, providing the audible output data 110 can cause the product dispenser 102 to transition from a first operating state to a second operating state as described in relation to the description of operating states 302-312 shown in FIGS. 3A-3B.

The generative language model 115 can be trained in a machine learning process that is specifically adapted to provide contextually relevant textual output data associated with one or more operating or display states of the product dispenser 102. For example, the generative language model 115 can be trained specifically for the sequence or workflows of prompts and prompt responses that are associated with the operating states 302-312 described in relation to FIGS. 3A-3B. For example, the training data can include variants of the display state data 121, 129 and variants of the pump state data 126. Such training data variants can be those that are associated with each of the operating states 302-312. In some embodiments, the training data can include data associated with goods or services which may be available in the dispensing environment where the product dispenser 102 is located. In this way, the generative language model 115 can be trained to answer ancillary dialog inputs that are less relevant to an operating state of the product dispenser 102.

In some embodiments, the generative language model 115 can be configured to generate textual outputs that correspond to one or more applications configured on the product dispenser 102, such as a weather application, a navigation application, a car wash application, or a point-of-sale application for purchasing an item or service at the product dispenser 102.

For example, the generative language model 115 can be trained on data that can be specific to one or more characteristics of a dispensed product, a dispensing activity or operation of the product dispenser, and the dispending environment, such as retail or service facilities that can be co-located with the product dispenser 102. With this training approach, the generative language model 115 can more accurately answer questions in a dialog with a user by generating responses that use words and sentences that are related to the dispensed product, dispensing activities or dispenser operating states, and the dispensing environment. The display state data 121, 129 and pump state data 126 can be used to predict what actions are permissible for a particular operating state, such as operating states 302-312, and thus, can enable the generative language model 115 to provide dialog responses that are contextually relevant to the actions and the operating states 302-312.

Advantageously, the generative language model 115 can receive the display state data 121, 129 and pump state data 126 as state data associated with the current operating state of the display 106 and/or the pump controller 138 of the product dispenser 102, in addition to the dialog inputs. Configuring the generative language model 115 in this manner is an improvement over existing generative language models configured to generate dialog responses. The use of the display state data 121, 129 and pump state data 126 (e.g., as prompt data 136) with the audible input data 109 can focus or restrict the generative language model 115 to generate only dialog outputs that are contextually relevant to the particular operating states 302-312 of the product dispenser 102. In some embodiments, the prompt data 136 associated with each of the operating states 302-312 can form a multi-dimensional matrix, such as an input state matrix, that can be associated with all permissible actions or contextually relevant dialog outputs that can be associated with the one or more operating states 302-312. For example, when the product dispenser 102 is in an authorized operating state to dispense a particular grade of fuel that has been selected, such as operating state 306, it is possible to start fueling but audible input data 109 associated with selecting a different fuel grade can be ignored. When the product dispenser 102 is not in an authorized operating state, it is not possible to start fueling and thus audible input data 109 requesting to begin fueling can also be ignored. In the above example, when in the authorized operating state 306, the generative language model 115 can maintain an operational and contextual awareness or dialog state such that the display state data 121, 129 may not include a “Please Wait” message, as the product dispenser 102 has already been authorized for dispensing the selected fuel grade.

In another example, the generative language model 115 can be configured such that selecting a fuel grade can be possible only when product dispenser 102 is already in the authorized operating state 306 and when the display state data 121, 129 does not include display of an advertisement. In another example, the generative language model 115 can be configured such that the product dispenser 102 can be in the authorized operating state 306 only when a payment mode has been selected and processed. Based on the contextually permissible response conditions defined via the input state matrix associated with the prompt data 136 and the audible input data 109, even if the generative language model 115 makes a mistake by trying to respond with an action or dialog output that is not contextually relevant to the immediate operating state or the dialog context, it will not be possible because the use of the pump state data 126 in conjunction with the display state data 121, 129 prevents such situations. Thus, the generative language model 115 is particularly and uniquely configured to generate contextually relevant dialog responses based on the combination of state data conditions of the display state data 121, 129 and pump state data 126 maintained in the input state matrix. In this way, the generative language model 115 can be configured to provide audible output data 110 and to control operation of the product dispenser 102 more accurately in regard to dialog inputs and operating states. As a result, the user experience at the product dispenser 102 can be enhanced and the product dispenser 102 can be operated in a more efficient manner.

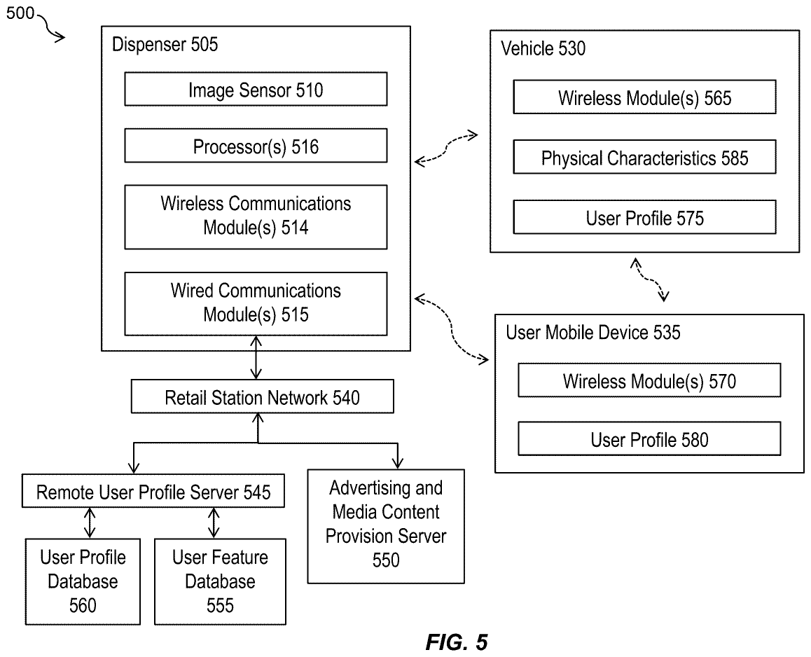

FIG. 5 is a system block diagram illustrating one embodiment of a dispensing system 500. The dispensing system 500 can correspond to the portions of the system 100 shown and described in relation to FIG. 1, such as the product dispenser 102, except where noted otherwise. The dispensing system 500 can be configured within a dispensing environment, which can include a plurality of dispensers 505 arranged about a dispensing environment forecourt, a retail sales facility or operation, and/or a vehicle service or maintenance facility or operation. The dispensing system 500 includes a dispenser 505 capable of exchanging data with a dispenser user, a vehicle, and/or a computing device of the dispenser user. The dispenser 505 can perform operations that include, but are not limited to, receiving inputs related to selecting products available via the dispenser 505, performing dispensing transactions, exchanging loyalty program data with users, displaying graphical and textual content associated with goods and services available within the dispensing environment, and receiving user inputs regarding the available goods and services.

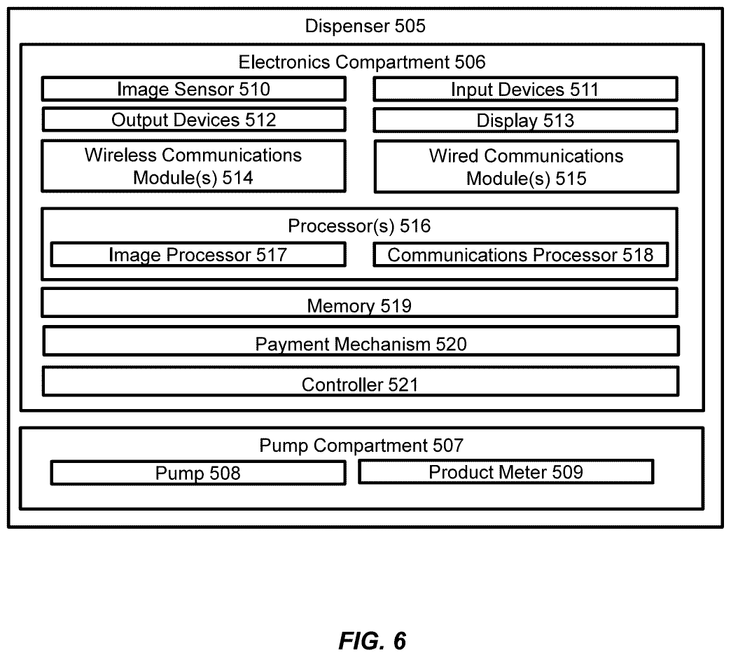

As shown in FIG. 6, the dispenser 505 can include an electronics compartment 506 and a pump compartment 507. The electronics compartment 506 can contain therein electronics for facilitating payment for dispensed products, such as fuel, and for facilitating dispensing of the dispensed products. In some embodiments, the electronics can facilitate payment for goods and services available within the dispensing environment, including but not limited to a food item, a beverage, a parking space, a pharmacy item, groceries to be delivered, a car wash, a tire pressure check, public transit, and the like. The electronics compartment 506 can include an image sensor 510, data processor(s) 516, wireless module(s) 514, wired communications module(s) 516, input devices 511, output devices 512 and a memory 519 or similar non-transitory storage medium configured to store computer-readable and executable instructions, which when executed by the processor 516 perform operations of the dispenser 505 described herein.

The image sensor 510 can include a thermochromic camera, an infrared camera, a digital still camera, or a video camera, although other optical sensors are possible. In some embodiments, the image sensor 510 can be affixed to an exterior surface of the dispenser 505. In some embodiments, the image sensor 510 can be configured within the dispensing environment and communicably coupled to the processors 516. The input devices 511 can include an alphanumeric keypad, a numeric keypad, a microphone, or the like. The output devices 512 can include a speaker, a printer, or the like.

The display 513 can be capable of providing information to a user of the dispenser 105. The display 513 can have a variety of configurations, such as a cathode ray tube (CRT) screen, a liquid crystal display (LCD) screen, a light emitting diode (LED) screen, a touchscreen, and the like. For example, the display 513 can include a single display. Alternatively, the display 513 can include multiple displays. For example, a first display 513 can be on a front side of the dispenser 505 and a second display 513 can be on a back side of the dispenser 505. As another example, the display 513 can include two displays mounted next to each other to increase an overall display size. As yet another example, the display 513 can include first and second displays mounted next to each other on a front side of the dispenser 505 and can include third and fourth mounted next to each other on a back side of the dispenser 505.

The communications modules, such as either of the wireless communications module(s) 514 or the wired communications module(s) 516 are capable of exchanging data between the dispenser 505 and computing devices communicably coupled to the dispenser 505. For example, in some embodiments, the wireless communication module(s) 514 can be capable of communicating or exchanging data wirelessly with a remote system (e.g., a remote cloud server, a third-party payment authorization system, etc.) utilizing a variety of communication protocols, e.g., TCP/IP, etc. In some implementations, the wireless communication module(s) 514 can be capable of facilitating wireless communication over a short-range communication link. For example, the wireless communication module(s) 514 can include a transceiver configured to communicate via any of a variety of short-range wireless techniques, such as a Bluetooth protocol, a Wi-Fi protocol, near field communication (NFC), an ultra-wideband (UWB) protocol, a radio frequency identification (RFID) protocol, etc. Any of a variety of types of wireless connectivity hardware can be used for the short-range wireless connectivity, as will be appreciated by a person skilled in the art. The types of wireless connectivity that the wireless communication module(s) 514 includes can be chosen by an owner of the dispensing system 500 according to the owner's current dispensing site setup and/or future dispensing environment plans, and the wireless communication module(s) 514 may be manufactured and/or updated accordingly.

In some embodiments, the wireless module(s) 514 can operatively connect the dispenser 505 with a vehicle 530 and a computing device 535, which in this embodiment is a user mobile device 535, as shown in FIG. 5. The wireless module 514 can include, e.g., a transceiver communicating via Bluetooth protocol, cellular protocol, WIFI protocol, near field communication (NFC), and/or a radio frequency identification (RFID) protocol. The wired communications module 116 operatively connects the dispenser 505 with a remote user profile server 545 and an advertising and media content provision server 550 via a retail station network 540. The retail station network 540 can connect multiple dispensers 505 together over a local area network (LAN).

In some embodiments, the wired communication module(s) 516 can be configured to communicate or exchange data over a wired connection in addition to or instead of over a wireless connection. A wired connection can be used, for example, for a local communication link between the dispenser 505 and a local computing system external to the dispenser 505 (e.g., a forecourt controller, an in-store a point of sale (POS) device, etc.). A wired connection may provide more security and/or stability than a wireless connection and/or may allow a legacy dispenser 505 configured to communicate only via one or more wired connections to implement dynamic management of content provided via the display 513. Wired communication can occur via any of a variety of wired communication protocols, e.g., TCP/IP, etc., as will be appreciated by a person skilled in the art. Some dispensers 505 are manufactured with two-wire connectivity, and the wired communication can accordingly be via two wires, such as via a controller area network bus (CAN Bus) two wire connection, an RS 485 two wire connection, a current loop connection, or other type of two wire connection. Some dispensers 505 are additionally or alternatively manufactured with cable connectivity and can accordingly be configured to provide wired communication via cable connection, such as an Ethernet cable or other network cable. Older dispensers 505 typically have two-wire connectivity capabilities while newer dispensers 505 typically have Ethernet connectivity capabilities instead.

The processor(s) 516 can include one or more processors forming part of at least one computing system. In one embodiment, the processor(s) 516 include at least an image processor 517 and a communications processor 518 as shown in FIG. 6. An image processor can receive one or more images from the image sensor 510 and determine identity information of a customer using the images. Identity information can include, for example, facial feature of a customer, a vehicle feature, a license plate number, a non-facial body feature, and the like. The image processor 517 can receive an image from image sensor 510, for example, when the dispenser 505 detects that a customer or user is proximate to the dispenser 505 and/or is in the field of view of the image sensor 510. The image can be of the customer (e.g., can contain a visual representation of the customer) and/or the customer's vehicle, for example. The image processor 517 is capable of performing operations, including but not limited to, receiving image data, and identifying physical characteristics of the user or a vehicle to determine regions within the image data in which the customer's face, body, and vehicle reside.

Using these regions, one or more image features related to the customer's face, body, and vehicle. For example, a facial feature can include skin texture; relative position, size, and/or shape of the eyes, nose, cheekbones, and jaw; and the like. Body features can include height, weight, hair color, body shape, and the like. Vehicle features can include shape, color, license plate number, manufacturer/make/model decal, and the like.

In at least some implementations, the image processor 517 is capable of classifying aspects of the image data as a vehicle, a non-facial body part, and/or a safety object or event. For example, the image processor 517 can classify (or determine) characteristics of the customer's vehicle based on the vehicle features. These characteristics can include, for example, license plate number, vehicle make, required grade and/or type of fuel for the vehicle, and vehicle model.

The image processor 517 is also capable of classifying (or determining) characteristics of the customer that do not directly derive the customer's identity based on the non-facial body features. For example, the image processor 517 is capable of determining a customer's height, weight age, gender, disability status (e.g., in a wheelchair or not in a wheelchair, etc.), and the like.

The image processor 517 is further capable of classifying (or determining) behavior of the customer that relates to safety and is based on an extracted feature present within the image data. For example, the image processor 517 can determine whether the customer is smoking, whether the customer is grounded prior to dispensing products or fuel, whether the vehicle engine is running during fueling, and whether the customer is about to “drive-off” (which can include leaving the fuel retailer without paying for dispensed products or fuel). Other determinations can include environmental, mechanical, electrical, and/or logical instruction conditions, such as, for example, temperature, pressure, humidity, fuel leaks, open panels, dispenser intrusion, power irregularities, watchdog timer expiration, and software exceptions.

Based on these classifications, the image processor 517 is capable of generating an alarm. The alarm can include a warning (e.g., signal, audio, light, and the like) to an attendant of the dispensing environment, such as at a site of the dispenser 505. The warning can include an audible sound emanating from the dispenser 505, a visual or graphical warning on the display 513 of the dispenser 505 indicating that products cannot be dispensed until the detected problem is corrected, and the like. Generating the alarm can include causing a corrective action to be performed, for example, restarting the dispenser 505 (e.g., in the event that a mechanical, electrical, and/or logical problem with the dispenser 505 is detected by the image processor 517), shutting down the dispenser 505 (e.g., in the event that an unsafe condition is detected by the image processor 517, such as the customer smoking before or during fueling, the customer not being grounded prior to dispensing fuel or products, the vehicle engine running during fueling, or a mechanical, electrical, and/or logical problem with the dispenser 505 being detected that cannot be fixed without manual intervention), downloading instructions for the dispenser 505 (e.g., to correct a mechanical, electrical, and/or logical problem with the dispenser 505), and/or generating notifications for other components at the fueling facility that includes the dispenser 505 (e.g., in the event an unsafe condition is detected by the image processor 517 that may affect safe functioning one or more other dispensers 505 within the dispensing environment).

In at least some implementations, image data including the facial features of a user or customer can be conveyed via the dispenser's communications module(s), such as the wireless module(s) 514 and/or the wired communications module(s) 516 to a remote user profile server 545, as described more fully below.

Referring again to FIG. 5, the dispenser 505 can transmit image data including facial features of a user or customer to a remote user profile server 545 in order to match the customer with a known customer identity. The remote user profile server 545 can receive the facial features and access a database 555 (which may include one or more databases) containing known customer features. The database 555 can contain features of customers that have previously visited the dispenser 505 or that have previously enrolled in a customer rewards program associated with the facility providing the dispenser 505 and provided an image of their face in association with the program. The database 555 can also associate unique identities (e.g., names or unique identifiers) with known facial features, e.g., in a table. The remote user profile server 545 can compare the received facial features with the features in the database 555 to find a match. If and once a match is found, the remote user profile server 545 can use the associated customer identifier to query a user profile database 560. The user profile database 560 can contain user profiles for each known customer in the feature database 555 (which may include one or more databases). User profiles can include preferences related to dispensed products (e.g., a preferred product grade, a product type, a payment method, a loyalty rewards identifier, whether to apply loyalty rewards to a present purchase, whether to purchase a car wash, and the like). The user profile and/or identity can be transmitted from the remote user profile server 545 to the dispenser 505.

The user profile and/or identity may be received by the communications processor 518 and can be stored in the memory 519. The user profile can be used by the communications processor 518 to provide a customized product dispensing experience. For example, the user profile can be accessed and the dispenser 505 can be configured with the customer's preferences. This can include rendering, on the display 513, a preference selection screen populated with the customer's dispensing preferences as specified in the user profile. In at least some implementations, the dispenser 505 can render a personalized greeting on the display 513.

In at least some implementations, identity information can be received by the communications processor 518. The identity information can include a name or unique identifier of the customer. This identity information can be used by the communications processor 518 to acquire the user profile from the remote user profile server 545. In at least some implementations the identity information can include, for example, facial features of the customer, vehicle features, license plate number, non-facial body features, and the like.

In at least some implementations, the user identity can be provided to an advertising and media content provision server 550, which can provide customized or targeted advertisements and content to the dispenser 505 for provision to the customer during dispensing of products, e.g., by displaying the advertisements and content on the display 513. For example, once the user identity is determined, advertisements can be dynamically determined and provided.

The advertisements can be pre-specified by remote merchants. Remote merchants can be any appropriate sellers of goods and/or services. For example, a merchant may sell durable goods (e.g., vehicle parts, toys, etc.), perishable goods (e.g., food, drink, etc.), intangible goods (e.g., software, digital media, etc.), or services (e.g., oil changes, car washes, etc.). Remote merchants can include any appropriate computer systems (e.g., servers and databases) for allowing them to send data regarding their goods and/or services over a communication network to fuel dispensers. Remote merchants can operate proactively, interactively, and/or or passively with fuel dispensers to market and/or sell their goods and/or services. For example, the remote merchants can download merchandising content (advertisements and pricing data) to the dispensers 505 at designated times or events, or the remote merchants can download merchandising content to the dispensers 505 upon request. In at least some implementations, the remote merchants can maintain a Web-based portal through which the dispensers 505 can download the content. As discussed herein, remote merchants are remote in the sense that they are not located at the dispensing environment that includes the dispensers 505 to which the remote merchants provide advertisements and/or other content. Thus, the remote merchants can be located in the neighborhood of the dispensing environment. One or more the merchants, of course, could be located at greater distances (e.g., across the state or country) from the dispensing environment.

Dynamic advertisements can include a listing of goods and/or services, along with descriptions and pricing information. The advertisements can include text, graphics, audio, and/or video for presentation at the dispenser 505.

Using the user profile and/or user identity information, the dispensers 505 can determine when to present the above-described merchant-provided data. For example, a dispenser 505 may present the data (e.g., on a display thereof) at certain points of a product dispensing session (e.g., while a product or a fuel is being dispensed or after dispensing the product or fuel is complete). The dispenser 505 can then determine whether the customer indicates interest in the merchant data (e.g., by detecting user input regarding the presented data). If the dispenser 505 detects user interest in the merchant-provided data, the dispenser 505 can present additional information regarding the goods and/or services and determine whether the customer desires to order a good and/or service. Additional information regarding goods or services can include textual descriptions, images, audio, and/or video.

If a customer desires to order a good and/or service, the dispenser 505 can acquire order data (e.g., quantity, price, and delivery information) or the order data can be included or inferred from the customer's user profile. The dispenser 505 can also acquire payment data or payment data may be included or inferred from the user profile. The dispenser 505 can also evaluate whether the payment data is sufficiently complete. If the payment data is acceptable, the dispenser 505 can then generate a message for the appropriate remote merchant regarding the order and payment information and generate a receipt for the customer. The appropriate merchant can then make arrangement for delivery of the good and/or service.

To facilitate customer interaction in at least some embodiments, the user profile can include customer-related data. The customer-related data can, for example, be associated with a customer identifier (e.g., a credit card number, a personal identification number (PIN), a telephone number, a radio frequency identifier (RFID) number, or a loyalty program number). The customer-related data can be information regarding a product dispensing session (e.g., a type of product or fuel, a display language for the dispenser display, audio settings for the dispenser, or payment preferences (e.g., certain credit card, certain debit card, cash to be paid at a staffed payment terminal, etc.)), data regarding services at the dispensing environment (e.g., car wash, air pump, or water hose), or data regarding the customer (e.g., address and preferred payment types). In at least some implementations, the customer-related data can be used to identify other information that may be of interest to the customer. For example, particular types of merchandise (e.g., drinks, newspapers, or food) or offers (e.g., coupons or advertising) can be presented to the customer based on customer-related data. This presentation can, for example, be based on the customer's past purchasing habits in a fueling facility store. The customer-related data can be acquired from the user profile and/or from a remote server using the customer identity.

In at least some implementations, the dispenser 505 can receive the user profile directly from a vehicle 330 (e.g., the customer's vehicle) and/or the mobile device 535. Each of the vehicle 530 and the mobile device 535 can include wireless module(s) 565, 570 (respectively) in communication with one another and with the wireless module(s) 514 of the dispenser 505. Communications between the vehicle 530 and the dispenser 505 can use an on-board diagnostics (OBD) mechanism of the vehicle 530, e.g., OBDII technology in which the vehicle 530 includes an OBDII port (cars manufactured after 1996 have an OBDII port). A copy of the user profile 580 can be contained on the customer's vehicle (for example, a smart vehicle having at least one data processor forming part of at least one computing system with the user profile stored in a memory of the at least one computing system) and/or a copy of the user profile 575 can be contained on the customer's mobile device 535 (e.g., in a memory thereof). When the dispenser 505 detects that the customer is proximate thereto (for example, via the image sensor 510 and/or the wireless module(s) 514), the wireless module(s) 514 can initiate a communication session with the vehicle 530 and/or the mobile device 535 and retrieve the customer's user profile. Once the user profile is received directly from the vehicle 530 or the mobile device 535, the customized dispensing experience can be provided as described above.

Returning to FIG. 6, the electronics compartment 506 can also include a payment mechanism 520 (e.g., a card reader, a Near Field Communication (NFC) module, etc.) configured to facilitate payment for dispensed products, such as fuel, (or other goods and services). The payment mechanism 520 can be configured to receive inputs such as, e.g., user identification information and/or payment information, and deliver the information to the controller 521. For example, the payment mechanism 520 can include a barcode and/or QR code scanner, and/or an NFC contactless card reader for receiving payment information, user identification information, vehicle information, and/or loyalty program information. In some embodiments, the payment mechanism 520 can be communicably coupled to a point-of-sale (POS) device or component. In some embodiments, the payment mechanism can include a pin-pad device, such as an SPM device as described herein.

The electronics compartment 506 can also include a controller 521 configured to receive instructions from the processor(s) 516 and generate one or more control signals controlling operations of components of the dispenser 505 in accordance with the operations described herein. In some embodiments, the controller 521 can include a data processor and a memory storing computer-readable and executable instructions, forming part of at least one computing system within the electronics compartment 506. In some embodiments, controller 521 can be operably coupled to components of the electronics compartment 506, such as the display 513, the image sensor 510, the wireless communication module(s) 514, the wired communication module(s) 515, the processor(s) 516, the memory 519, and the payment mechanism 520, and the controller 521 can be configured to control operations thereof. In some embodiments, the controller 521 can be configured as a fuel controller and can be operatively coupled to components of the pump compartment 507, such as the pump 508 or the product meter 509. The fuel controller 521 can generate control signals controlling operations of the pump 508 or the product meter 509.

The pump compartment 507 houses a pump 508 configured to provide a liquid dispensed product, such as fuel, from a storage tank or other reservoir. The pump compartment 507 can also include one or more product meters 509 that can be configured to monitor flow of dispensed products, flow of additives added to the dispensed product, and/or flow of other components of the dispensed product fuel. The pump compartment 507 can also include other components to facilitate product dispensing and mixing, such as motors and valves, a strainer/filtering system, a vapor recovery system, and the like. The pump compartment 507 is isolated from the electronics compartment 506 within the dispenser 505 to facilitate safety, security, and/or maintenance, as will be appreciated by a person skilled in the art. Dispensed products do not flow or are not conveyed from the pump compartment 507 to the electronics compartment 506 and instead the dispensed products, such as fuel, flow or otherwise are conveyed through the pump compartment 507 to a dispensing device of the dispenser 505, such as a hose and a nozzle at an end of the hose. The dispenser 505 can include any number of hoses and associated nozzles.

A person skilled in the art will appreciate that the dispenser 505 can have various other configurations. Various exemplary implementations of dispensers and methods of provisioning software thereto are described further in, for example, U.S. Pat. No. 10,214,411 entitled “Fuel Dispenser Communication” issued Feb. 26, 2019; U.S. Pat. No. 10,269,082 entitled “Intelligent Fuel Dispensers” issued Apr. 23, 2019; U.S. Pat. No. 10,577,237 entitled “Methods And Devices For Fuel Dispenser Electronic Communication” issued Mar. 3, 2020; U.S. Pat. No. 10,726,508 entitled “Intelligent Fuel Dispensers” issued Jul. 28, 2020; U.S. Pat. No. 11,276,051 entitled “Systems And Methods For Convenient And Secure Mobile Transactions” issued Mar. 15, 2022; U.S. Pat. No. 11,429,945 entitled “Outdoor Payment Terminals” issued Aug. 30, 2022; U.S. Pat. No. 11,443,582 entitled “Virtual Payment System and Method for Dispensing Fuel” issued Sep. 13, 2022; U.S. Pat. App. Pub. No. 2023/0196360 entitled “Conducting Fuel Dispensing Transactions” published Jun. 22, 2023, and U.S. Pat. App. Pub. No. 2023/0103400 entitled “Intelligent Electronic Fueling Station Component Provisioning” published Apr. 6, 2023, each of which are hereby incorporated by reference in their entireties.

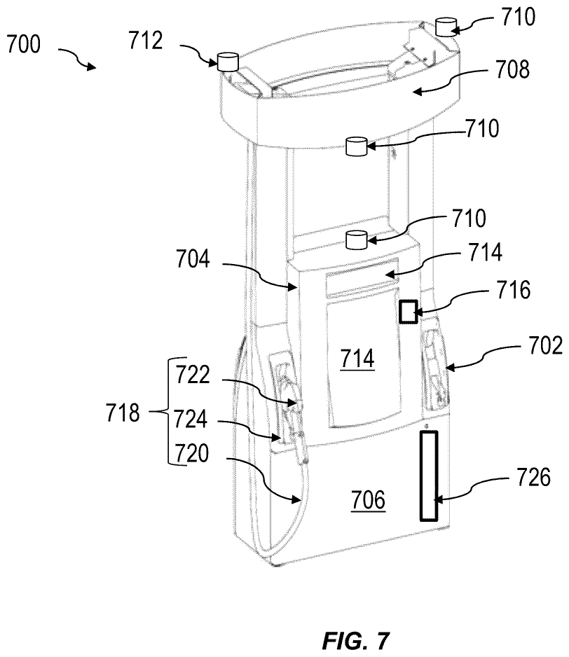

FIG. 7 illustrates a perspective view of one embodiment of a dispenser 700. The dispenser 700 is an embodiment of dispenser 102 and 505 of FIGS. 1 and 5-6. The dispenser 700 can be configured to dispense liquid products (e.g., petroleum fuel). For example, in some embodiments, the dispenser 7200 can be configured to dispense liquid products such as gasoline, diesel fuel, ethanol-based fuels, biofuels, diesel exhaust fluid (DEF), fuel additives (e.g., acetone, ether, nitrous oxide, nitromethane, butyl rubber, ferox, oxyhydrogen), water and the like.

As shown in FIG. 7, the dispenser 700 can include a dispenser body 702 in which the electronics compartment 704 and the pump compartment 706 are configured. The dispenser 700 can also include a dispenser awning 708 coupled to the dispenser body 702. In some embodiments, the dispenser body 702 can include the dispenser awning 708. In some embodiments, the dispenser body 702 can exclude the dispenser awning 708. The dispenser awning 708 can include at least one image sensor 710 and at least one wireless transmission module 712 configured thereon. In some embodiments, the dispenser body 702 can, additionally or alternatively, include an image sensor 710. As further shown, the dispenser body 702 can include a display 714, a payment mechanism 716, and a dispensing assembly 718.

The dispenser body 702 can include an electronics compartment 704 and a pump compartment 706. The pump compartment 706 is isolated from the electronics compartment 704 within the dispenser 700 to facilitate safety, security, and/or maintenance, as will be appreciated by a person skilled in the art. Dispensed products or fuel is thus not allowed to flow from the pump compartment 706 to the electronics compartment 704 and instead flows from the pump compartment 706 to the dispensing assembly 718. The dispensing assembly 718 can include a hose 720 coupled to a nozzle 722 for dispensing the liquid product. As will be appreciated by a person skilled in the art, the nozzle 722 can be configured to dispense the liquid product from the dispenser 700 as pumped therefrom by the pump 508. The dispensing assembly 718 can also include a nozzle receptacle 724 configured to store the nozzle 722 when not in use. In some embodiments, the dispenser 700 can include 1, 2, 3, 4, 5, or 6 dispensing assemblies 718. In some embodiments, one or more first dispensing assemblies 718 can be provided on a first side of the dispenser 700 and one or more second dispensing assemblies 718 can be provided on a second side of the dispenser 700 that is opposite the first side of the dispenser 700.

In some embodiments, the dispenser 700 can be configured to dispense diesel exhaust fluid (DEF) and can include a heater 726 within the pump compartment 706 of the dispenser body 702. The heater 726 can be configured to heat the DEF and portions of the pump compartment 706 and/or dispensing assemblies 718. Heating components of the dispenser 700 can be advantageous in climates where freezing temperatures are a concern.

In some implementations, the dispensers described herein can be configured to other types of dispensed products, in addition to or instead of a liquid dispensed product. For example, the dispenser can be configured to dispense products in a gaseous format, such as hydrogen, compressed natural gas (CNG), liquified natural gas (LNG), electricity, or the like. It will be understood that the dispensing environments, dispensing systems, and the dispensers described herein are not limited to dispensing products in liquid format and that the dispensing environments, dispensing systems, and the dispensers described herein can, additionally or alternatively, be configured to dispense products in non-liquid product formats, such as a vapor, a gas, or electricity. For example, in some implementations, the dispenser 700 can be a hydrogen dispenser. As another example, in some implementations, the dispenser 700 can be a compressed natural gas dispenser. As yet another example, in some implementations, the dispenser 700 can be an electrical fuel dispenser configured to dispense electricity.

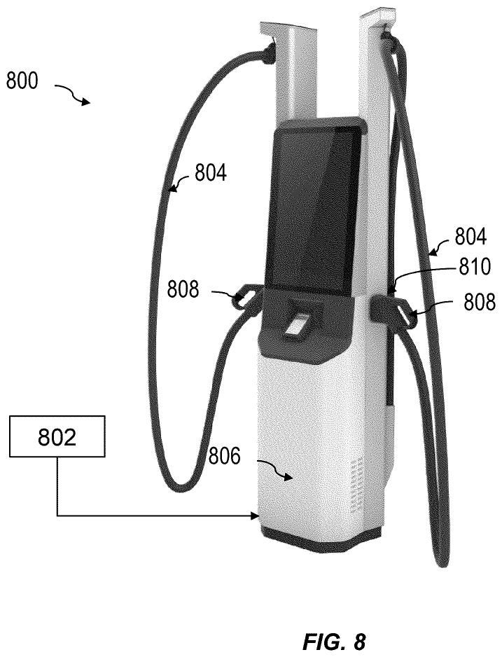

The dispenser 800 of FIG. 8 is another embodiment of the dispenser 102 of FIG. 1, the dispenser 505 of FIGS. 5-6 and the dispenser 700 of FIG. 7, except where noted otherwise. The dispenser 800 can be configured to dispense electricity. For example, the dispenser 800 can be configured as an electric vehicle charger. The dispenser 800 can be operatively coupled to a power supply 802, such as a local or regional power grid, a battery-back up power supply, a retail sales facility, or a vehicle service facility located in proximity of the dispenser 800.

The dispenser 800 can include a charging cable 804 coupled to a dispenser body 806 of the dispenser 800. In some embodiments, the dispenser 800 can include multiple charging cables 804 as shown in FIG. 11 and is not limited to a configuration having a single charging cable 804. The charging cable 804 can be configured to deliver electricity to a charging connector 808. The charging connector 808 can be configured to couple to a charging port of a vehicle and to deliver the electricity provided by the dispenser 800, via the charging cable 804, to the vehicle when the charging connector 808 is coupled to the vehicle charging port. When not in use, the charging connector 808 is configured to be stored in a charger receptacle 810 formed on the dispenser body 806.

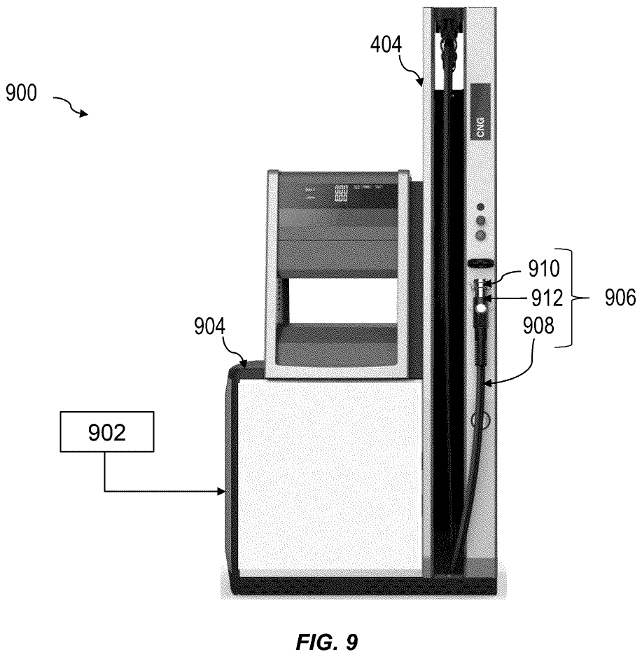

The dispenser 900 shown in FIG. 9 is another embodiment of the dispenser 102 of FIG. 1, the dispenser 505 of FIGS. 5-6, the dispenser 700 of FIG. 7, and the dispenser 800 of FIG. 8, except where noted otherwise. The dispenser 900 can be configured to dispense gaseous products such as compressed natural gas (CNG). In some embodiments, the dispenser 900 can alternatively be configured to dispense, liquified petroleum gas (LPG), hydrogen, and liquified natural gas (LNG). For example, the dispenser 900 can be operatively coupled to a gas supply 902 of CNG or other gaseous product, such as a local or regional pipeline, a stored gas supply located within the dispensing environment with the dispenser 900, or a mobile tube trailer in proximity of the dispenser 900.

The dispenser 900 can also include one or more dispensing assemblies 906 configured within the dispenser body 904. The dispensing assembly 906 can include a hose 908 coupled to a nozzle 910 for dispensing the gaseous CNG product. As will be appreciated by a person skilled in the art, the nozzle 910 can be configured to dispense the CNG product from the dispenser 900. The dispensing assembly 906 can also include a nozzle receptacle 912 configured to store the nozzle 910 when not in use. In some embodiments, the dispenser 900 can include 1, 2, 3, 4, 5, or 6 dispensing assemblies 906. In some embodiments, one or more first dispensing assemblies 906 can be provided on a first side of the dispenser 900 and one or more second dispensing assemblies 906 can be provided on a second side of the dispenser 900 that is opposite the first side of the dispenser 900.

In some embodiments, the dispensers described herein can be configured to dispense multiple product types. For example, a first portion of a dispenser including a first dispensing assembly can be configured to dispense a liquid product, such as petroleum or DEF, and a second portion of the same dispenser can include a second dispensing assembly configured to dispense a non-liquid product, such as electricity or a gaseous product, such as CNG, LNG, LPG, or Hydrogen. A variety of combinations of dispensing portions and assemblies necessary to dispense multiple, different dispensed products can be envisioned within a single dispenser body of a dispenser as described herein.

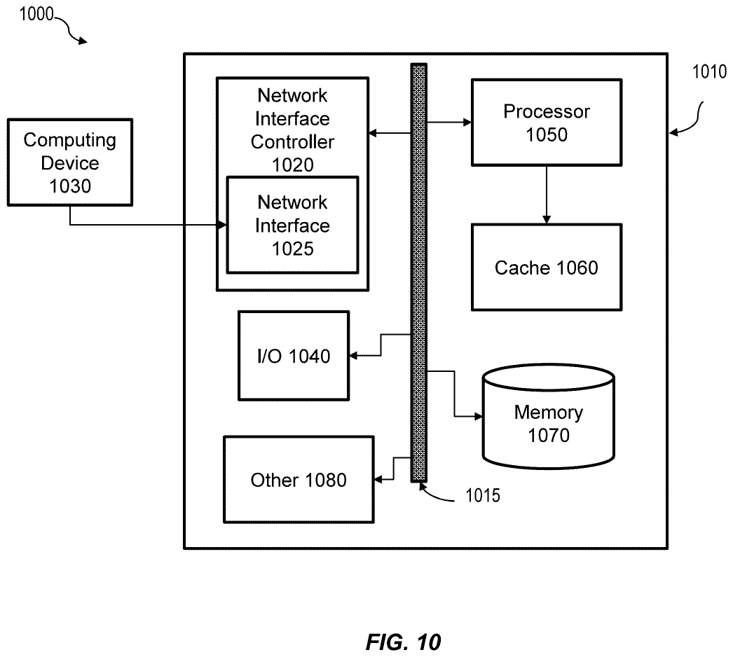

FIG. 10 is a block diagram 1000 of a computing system 1010 suitable for use in implementing the computerized components described herein. In broad overview, the computing system 1010 includes at least one processor 1050 for performing actions in accordance with instructions, and one or more memory devices 1060 and/or 1070 for storing instructions and data. The illustrated example computing system 1010 includes one or more processors 1050 in communication, via a bus 1015, with memory 1070 and with at least one network interface controller 1020 with a network interface 1025 for connecting to external devices 1030, e.g., a computing device. The one or more processors 1050 are also in communication, via the bus 1015, with each other and with any I/O devices at one or more I/O interfaces 1040, and any other devices 1080. The processor 1050 illustrated incorporates, or is directly connected to, cache memory 1060. Generally, a processor will execute instructions received from memory. In some embodiments, the computing system 1010 can be configured within a cloud computing environment, a virtual or containerized computing environment, and/or a web-based microservices environment.

In more detail, the processor 1050 can be any logic circuitry that processes instructions, e.g., instructions fetched from the memory 1070 or cache 1060. In many embodiments, the processor 1050 is an embedded processor, a microprocessor unit or special purpose processor. The computing system 1010 can be based on any processor, e.g., suitable digital signal processor (DSP), or set of processors, capable of operating as described herein. In some embodiments, the processor 1050 can be a single core or multi-core processor. In some embodiments, the processor 1050 can be composed of multiple processors.

The memory 1070 can be any device suitable for storing computer readable data. The memory 1070 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid-state memory), magnetic disks, and magneto optical disks. A computing device 1010 can have any number of memory devices 1070.

The cache memory 1060 is generally a form of high-speed computer memory placed in close proximity to the processor 1050 for fast read/write times. In some implementations, the cache memory 1060 is part of, or on the same chip as, the processor 1050.

The network interface controller 1020 manages data exchanges via the network interface 1025. The network interface controller 1020 handles the physical, media access control, and data link layers of the Open Systems Interconnect (OSI) model for network communication. In some implementations, some of the network interface controller's tasks are handled by the processor 1050. In some implementations, the network interface controller 1020 is part of the processor 1050. In some implementations, a computing device 1010 has multiple network interface controllers 1020. In some implementations, the network interface 1025 is a connection point for a physical network link, e.g., an RJ 45 connector. In some implementations, the network interface controller 1020 supports wireless network connections and an interface port 1025 is a wireless Bluetooth transceiver. Generally, a computing device 1010 exchanges data with other network devices 1030, such as computing device 1030, via physical or wireless links to a network interface 1025. In some implementations, the network interface controller 1020 implements a network protocol such as LTE, TCP/IP Ethernet, IEEE 802.11, IEEE 802.16, Bluetooth, or the like.

The other computing devices 1030 are connected to the computing device 1010 via a network interface port 1025. The other computing device 1030 can be a peer computing device, a network device, a server, or any other computing device with network functionality. In some embodiments, the computing device 1030 can be a network device such as a hub, a bridge, a switch, or a router, connecting the computing device 1010 to a data network such as the Internet.

In some uses, the I/O interface 1040 supports an input device and/or an output device (not shown). In some uses, the input device and the output device are integrated into the same hardware, e.g., as in a touch screen. In some uses, such as in a server context, there is no I/O interface 1040 or the I/O interface 1040 is not used. In some uses, additional other components 1080 are in communication with the computer system 1010, e.g., external devices connected via a universal serial bus (USB).

The other devices 1080 can include an I/O interface 1040, external serial device ports, and any additional co-processors. For example, a computing system 1010 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 1010, e.g., a touch screen on a tablet device. In some implementations, a computing device 1010 includes an additional device 1080 such as a co-processor, e.g., a math co-processor that can assist the processor 1050 with high precision or complex calculations.

Although a few variations have been described in detail above, other modifications or additions are possible. For example, although generative language model 115 is described in relation to generating textual output data associated with a user of a product dispenser for the purpose of controlling an operating state of the product dispenser, in some embodiments, the generative language model 115 can be configured to generate textual output data for use in a user dialog regarding availability and use of facilities, services, or items that may be co-located with the product dispenser, such as a car wash, a retail facility, or food and service items available to purchase via the product dispenser. In some embodiments, the generative language model 115 can be configured to perform dialogs with a user regarding one or more applications configured on the product dispenser, such as a weather application, a navigation application, a food delivery service application, a loyalty program application, or the like.

Without in any way limiting the scope, interpretation, or application of the claims appearing below, a technical effect of one or more of the example implementations disclosed herein may include one or more of the following, for example, some example implementations of the current subject matter can perform provision of contextually relevant audible dialogs configured to control operation of a product dispenser. As such, the system and methods herein can provide an improved computer system configured to generate audible dialog response data based on display states and operating states of the product dispenser. In this way, the product dispenser can more accurately depict displayed data to a user performing a fueling transaction and can perform execution of control signals that are specifically associated with audible dialog inputs or outputs. As a result, the overall operating efficiency of the product dispenser can be improved. Additionally, the user experience can be improved by unifying displayed data and product dispenser operational state to more accurately reflect a particular context of a dialog performed with a user. Further, by utilizing display and operational state data in conjunction with textual input data (associated with the audible dialog inputs), the dialog processing subsystem described herein can produce more robust contextually relevant textual and audible dialog outputs than if the generative language model was trained solely based on the audible input data without any cognizance of display state data or operating state data associated with the product dispenser.

The display state data and operational state data can be used in the machine learning process to train the generative language model to generate the textual dialog output data more accurately since the display and operational state data can provide additional context for generating dialog output data and product dispenser control signals than if such training data of inputs were not used. For example, receiving prompt data 136 (as state data 121, 126, and 129 and the textual input data (associated with audible input data 109), the generative language model 115 can generate a contextually relevant dialog response (as textual output data) based on what data is displayed on the display 106 and/or a state of the pump of the product dispenser 102. Since the model 115 is trained to generate dialog outputs based on this data, in addition to the user dialog inputs, the model 115 can provide dialog outputs with greater contextual accuracy about the user's intent to control the product dispenser 102 than if no state data was included in the prompt data 136. As a result, the computational processing required by the generative language model 115 to generate a contextually accurate dialog response is reduced because the generative language model 115 does not need to perform additional dialog iterations with the user to determine their desired intent operating the product dispenser. As such, the computing device 112 is an improved computing device configured to provide a novel approach to dialog generation for use in product dispenser operation and control.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. A method comprising:
receiving, by a dialog processing system communicably coupled to a product dispenser, audible input data acquired via at least one input device of the product dispenser responsive to a first indication of a first operating state of the product dispenser, the audible input data received in an audible dialog configured to control one or more operating states of the product dispenser;
converting, by the dialog processing system, the audible input data to textual input data;
determining, by the dialog processing system, state data corresponding to the first operating state and associated with the audible input data;
determining, by a predictive model of the dialog processing system, textual output data corresponding to the textual input data and the state data, the predictive model trained in a machine learning process to receive textual input data and state data including display state data and operating state data associated with the one or more operating states of the product dispenser and to generate textual output data contextually relevant to the textual input data and the one or more operating states of the product dispenser;
determining, by the dialog processing system, at least one execution role of the product dispenser associated with the first operating state based on the textual output data;
converting, by the dialog processing system, the textual output data to audible output data responsive to determining the textual output data corresponds to the at least one execution role of the product dispenser; and
providing, via the at least one output device of the product dispenser, the audible output data in the audible dialog such that the product dispenser transitions from the first operating state to a second operating state.

2. The method of claim 1, wherein the at least one execution role includes a first execution role associated with providing the audible dialog and a second execution role with executing functionality associated with the one or more operating states of the product dispenser.

3. The method of claim 2, wherein responsive to determining the textual output data corresponds to the first execution role, the method further comprises providing the audible output data via a second indication of the second operating state of the product dispenser.

4. The method of claim 3, wherein the first indication of the first operating state or the second indication of the second operating state of the product dispenser are provided after expiration of a pre-determined period of time in which no audible input data is acquired via the at least one input device.

5. The method of claim 2, wherein responsive to determining the textual output data corresponds to the second execution role, the method further comprises generating control signals configured to control the product dispenser to transition from the first operating state to the second operating state.

6. The method of claim 5, wherein responsive to executing the generated control signals, the second operating state is configured to provide one or more applications for display via the at least one output device, the one or more applications including at least one of a weather application, a car wash application, and a point-of-sale application for purchasing an item or service at the product dispenser.

7. The method of claim 1, wherein the state data characterizes at least one of a display state of a display of the product dispenser and a pump state of a pump of the product dispenser.

8. The method of claim 7, wherein the display state data characterizes at least one an activity message state, a softkey state, a grade key state, a stop button state, a volume state, a display language state, and a display contrast state and the pump state data characterizes at least one of an idle pump state and an active pump state.

9. The method of claim 1, wherein the machine learning process in which the predictive model is trained is configured to train the predictive model to generate textual output data for use in the audible dialog with a user of the product dispenser, the dialog being contextually relevant to the first operating state or the second operating state.

10. The method of claim 1, wherein at least one of the first operating state and the second operating state includes at least one of an idle state, a transaction initialization state, a payment preauthorization state, a dispensing start state, a dispensing complete state, a receipt creation state, and a transaction complete state.

11. The method of claim 1, wherein the first indication of the first operating state is provided after the product dispenser is in an idle state and responsive to detecting a user of the product dispenser.

12. The method of claim 1, wherein the at least one output device of the product dispenser includes a display or a speaker.

13. The method of claim 1, wherein the at least one input device of the product dispenser includes a display or a microphone.

14. A system comprising:
a product dispenser including at least one input device and at least one output device; and
a dialog processing system communicably coupled to the product dispenser and including a memory storing computer-executable instructions, a predictive model trained in a machine learning process to receive textual input data and state data including display state data and operating state data associated with one or more operating states of the product dispenser and to generate textual output data contextually relevant to the textual input data and one or more operating states of the product dispenser, and a data processor configured to execute the instructions, which when executed cause the data processor to perform operations comprising
receiving audible input data acquired via the at least one input device of the product dispenser responsive to a first indication of a first operating state of the product dispenser, the audible input data received in an audible dialog configured to control one or more operating states of the product dispenser,
converting the audible input data to textual input data,
determining state data corresponding to the first operating state and associated with the audible input data,
determining, by the predictive model, textual output data corresponding to the textual input data and the state data,
determining at least one execution role of the product dispenser associated with the first operating state based on the textual output data,
converting the textual output data to audible output data responsive to determining the textual output data corresponds to the at least one execution role of the product dispenser, and
causing the audible output data to be provided in the audible dialog such that the product dispenser transitions from the first operating state to a second operating state.

15. The system of claim 14, wherein the at least one execution role includes a first execution role associated with providing the audible dialog and a second dialog execution role associated with executing functionality associated with the one or more operating states of the product dispenser.

16. The system of claim 15, wherein responsive to determining the textual output data corresponds to the first execution role, the instructions are further configured to provide the audible output data via a second indication of the second operating state of the product dispenser.

17. The method of claim 16, wherein the instructions are further configured to provide the first indication of the first operating state or the second indication of the second operating state of the product dispenser after expiration of a pre-determined period of time in which no audible input data is acquired via the at least one input device.

18. The system of claim 15, wherein responsive to determining the textual output data corresponds to the second execution role, the instructions are further configured to cause the data processor to generate control signals configured to control the product dispenser to transition from the first operating state to the second operating state.

19. The system of claim 18, wherein responsive to executing the generated control signals, the second operating state is configured to provide one or more applications for display via the at least one output device, the one or more applications including at least one of a weather application, a car wash application, and a point-of-sale application for purchasing an item or service at the product dispenser.

20. The system of claim 14, wherein the state data characterizes at least one of a display state of a display of the product dispenser and a pump state of a pump of the product dispenser.

21. The system of claim 20, wherein the display state data characterizes at least one an activity message state, a softkey state, a grade key state, a stop button state, a volume state, a display language state, and a display contrast state and the pump state data characterizes at least one of an idle pump state and an active pump state.

22. The system of claim 14, wherein the machine learning process in which the predictive model is trained is configured to train the predictive model to generate textual output data for use in the audible dialog with a user of the product dispenser, the dialog being contextually relevant to the first operating state or the second operating state.

23. The system of claim 14, wherein at least one of the first operating state and the second operating state includes at least one of an idle state, a transaction initialization state, a payment preauthorization state, a dispensing start state, a dispensing complete state, a receipt creation state, and a transaction complete state.

24. The system of claim 14, wherein the first indication of the first operating state is provided after the product dispenser is in an idle state and responsive to detecting a user of the product dispenser.

25. The system of claim 14, wherein the at least one output device of the product dispenser includes a display or a speaker.

26. The system of claim 14, wherein the at least one input device of the product dispenser includes a display or a microphone.
